(19) United States
(12) Patent Application Publication
(10) Pub. No.: US 2014/0161406 A1
(43) Pub. Date: Jun. 12, 2014

(54) METHOD OF MANUFACTURING OPTICAL FIBER PREFORM AND OPTICAL FIBER

(71) Applicant: FURUKAWA ELECTRIC CO., LTD., Tokyo (JP)

(72) Inventor: Naomi KUMANO, Tokyo (JP)

(73) Assignee: FURUKAWA ELECTRIC CO., LTD, Tokyo (JP)

(21) Appl. No.: 14/175,624

(22) Filed: Feb. 7, 2014

Related U.S. Application Data
(63) Continuation-in-part of application No. PCT/JP2012/067361, filed on Jul. 6, 2012.

(30) Foreign Application Priority Data
Aug. 9, 2011 (JP) 2011-174172

(51) Int. Cl. C03B 37/014; C03C 25/10; G02B 6/036

(52) U.S. Cl. CPC C03B 37/0144; G02B 6/03622; C03C 25/104
USPC 385/128; 65/397

(57) ABSTRACT

A method of manufacturing an optical fiber preform includes forming a porous body that is made of glass particles and includes a first region and a second region formed on an outer circumference of the first region, performing a first heat treatment on the porous body under an atmosphere containing a fluorine gas, performing a second heat treatment on the porous body after the first heat treatment at a higher temperature than that of the first heat treatment to form a transparent glass body, and forming a cladding portion on an outer circumference of the transparent glass body.

### CROSS-REFERENCE TO RELATED APPLICATIONS

This application is a continuation-in-part of PCT international application Ser. No. PCT/JP2012/067361 filed on Jul. 6, 2012 which designates the United States, incorporated herein by reference, and which claims the benefit of priority from Japanese Patent Applications No. 2011-174172, filed on Aug. 9, 2011, incorporated herein by reference.

### BACKGROUND

1. Technical Field

The disclosure relates to a method of manufacturing an optical fiber preform and an optical fiber.

2. Related Art

An optical fiber having a W-shaped refractive index profile is known that includes a center core portion, a depressed layer that is formed on an outer circumference of the center core portion and has a lower refractive index than that of the center core portion, and a cladding portion that is formed on an outer circumference of the depressed layer and has a higher refractive index than that of the depressed layer.

As a method of manufacturing an optical fiber preform for manufacturing such an optical fiber, the following method is known. First, a porous body (soot) made of quartz glass particles is formed by the vapor phase axial deposition (VAD) method. The porous body includes a first region to be the center core portion. Germanium (Ge) that is dopant for increasing a refractive index of quartz glass is added to the porous body, for example. Next, the porous body is dehydrated and sintered for vitrification to form a transparent glass body. Thereafter, a porous layer (soot) made of quartz glass particles is formed on an outer circumference of the transparent glass body by the outer vapor deposition (OVD) method, and the porous layer is sintered again for vitrification, and thus an outer diameter of the transparent glass body is enlarged. In the process of vitrification, fluorine (F) that is dopant for decreasing a refractive index of quartz glass is added. In this manner, the transparent glass body including the center core portion and the depressed layer is formed. Finally, a cladding portion is formed on the glass body by the OVD method, etc. to obtain an optical fiber preform.

An alternative method of forming a transparent glass body including a center core portion and a depressed layer is also known. In the alternative method, a porous body having a first region to be the center core portion and a second region to be the depressed layer are formed altogether by the VAD method, and fluorine that is dopant for decreasing a refractive index of quartz glass is added to the second region from the outer circumference of the porous body in the process of vitrification (see Japanese Patent Application Laid-open No. 62-182129, Japanese Patent Application Laid-open No. 2000-159531, Japanese Patent Application Laid-open No. 60-161347, and Japanese Patent Application Laid-open No. 61-31324, for example).

However, the methods disclosed in the above-mentioned patent documents require three-step heat treatment including heat treatment for adding fluorine for vitrification from dehydration to sintering, which results in time-consuming processes.

Accordingly, there is a need to provide a method of manufacturing an optical fiber preform that makes it possible to manufacture the optical fiber preform more easily in a short time, and to provide an optical fiber using the optical fiber preform.

### SUMMARY

In accordance with some embodiments, a method of manufacturing an optical fiber preform and an optical fiber are presented.

In some embodiments, a method of manufacturing an optical fiber preform includes forming a porous body that is made of glass particles and includes a first region and a second region formed on an outer circumference of the first region, performing a first heat treatment on the porous body under an atmosphere containing a fluorine gas, performing a second heat treatment on the porous body after the first heat treatment at a higher temperature than that of the first heat treatment to form a transparent glass body, and forming a cladding portion on an outer circumference of the transparent glass body.

In some embodiments, an optical fiber includes a center core portion located at a center of the optical fiber, a depressed layer that surrounds the center core portion and has a refractive index lower than that of the center core portion, and a cladding portion that surrounds the depressed layer and has a refractive index lower than that of the center core portion and higher than that of the depressed layer. A manufacturing boundary is not generated between the center core portion and the depressed layer. Fluorine is added to the depressed layer, and fluorine is not added to the center core portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a cross section and a refractive index profile of an optical fiber preform manufactured by a manufacturing method according to some embodiments;

FIG. 2 is a flowchart illustrating the method of manufacturing the optical fiber preform and a method of manufacturing an optical fiber according to some embodiments;

FIG. 3 is a schematic diagram for explaining a porous body forming process;

FIG. 4 is a schematic diagram for explaining a first heat treatment;

FIG. 5 is a schematic diagram for explaining a cladding portion forming process;

FIG. 6 is a schematic diagram illustrating refractive index profiles of optical fiber preforms of Comparative example and Examples 1-1 and 1-2;

FIG. 7 is a table illustrating the characteristics of optical fibers manufactured using the optical fiber preforms of Comparative Example and Examples 1-1 and 1-2;

FIG. 8 is a schematic diagram illustrating refractive index profiles of optical fiber preforms of Comparative Example and Examples 2-1 to 2-3;

FIG. 9 is a table illustrating the characteristics of optical fibers manufactured using the optical fiber preforms of Comparative Example and Examples 2-1 to 2-3;

FIG. 10 is a schematic diagram illustrating refractive index profiles of optical fiber preforms of Comparative Example and Examples 3-1-1 and 3-1-2;

FIG. 11 is a table illustrating the characteristics of optical fibers manufactured using the optical fiber preforms of Comparative Example and Examples 3-1-1 to 3-2-5;

FIG. 12 is a schematic diagram illustrating refractive index profiles of optical fiber preforms of Comparative Example and Examples 4-1 and 4-2;

FIG. 13 is a table illustrating the characteristics of optical fibers manufactured using the optical fiber preforms of Comparative Example and Examples 4-1 and 4-2; and

FIG. 14 is a table illustrating examples of preferable design parameters and characteristics of optical fibers achieved by the design parameters.

### DETAILED DESCRIPTION

Exemplary embodiments of a method of manufacturing an optical fiber preform and a method of manufacturing an optical fiber will be explained in detail below with reference to the accompanying drawings. The invention is not limited to the following embodiments. In the description, a cut-off wavelength indicates a cut-off wavelength in the 22-m method defined in International Telecommunication Union Telecommunication Standardization Sector (ITU-T) G.650.1. The other terms that are not particularly defined in the description are in accordance with the definitions and the measuring methods in ITU-T G.650.1.

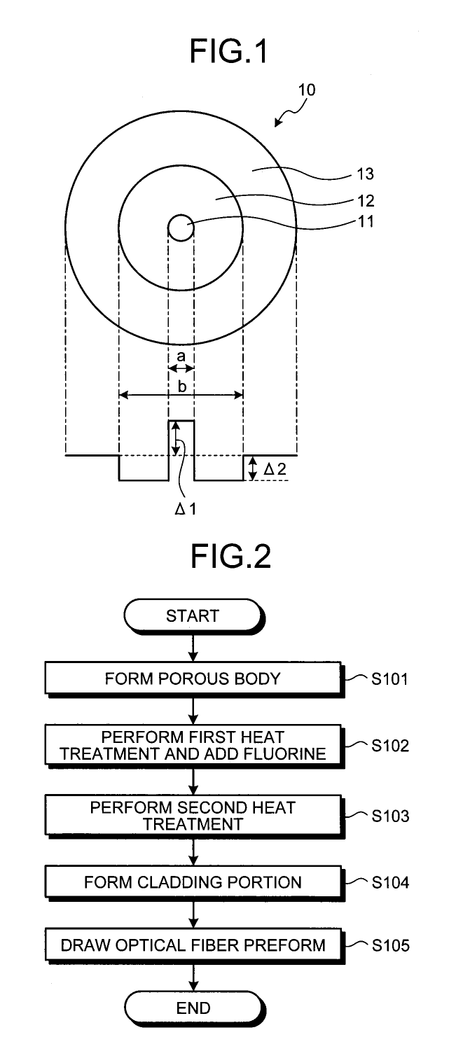

Exemplary embodiments of a method of manufacturing an optical fiber preform and a method of manufacturing an optical fiber using the optical fiber preform will be described. FIG. 1 is a schematic diagram illustrating a cross section and a refractive index profile of an optical fiber preform manufactured by the manufacturing method according to some embodiments. As illustrated in FIG. 1, an optical fiber preform 10 includes a center core portion 11, a depressed layer 12 formed on an outer circumference of the center core portion 11, and a cladding portion 13 formed on an outer circumference of the depressed layer 12.

The center core portion 11 is made of quartz glass to which dopant for increasing a refractive index such as germanium is added. The depressed layer 12 is made of quartz glass to which fluorine is added. The cladding portion 13 is made of pure quartz glass that does not contain dopant for adjusting a refractive index. With this structure, the refractive index of the depressed layer 12 is lower than that of the center core portion 11, and the refractive index of the cladding portion 13 is higher than that of the depressed layer 12. Thus, the optical fiber preform 10 has what is called a W-shaped refractive index profile.

As illustrated in the refractive index profile, a relative refractive-index difference of the center core portion 11 to the cladding portion 13 is denoted by Δ1, and a relative refractive-index difference of the depressed layer 12 to the cladding portion 13 is denoted by Δ2. A diameter “a” of the center core portion 11 (hereinafter referred to as core diameter) is a diameter at a position where the relative refractive-index difference Δ1 is 0% at a boundary between the center core portion 11 and the depressed layer 12. An outer diameter “b” of the depressed layer 12 is a diameter at a position where a relative refractive-index difference is ½ of the relative refractive-index difference Δ2 at a boundary between the depressed layer 12 and the cladding portion 13.

Next, the method of manufacturing the optical fiber preform and the method of manufacturing the optical fiber according to some embodiments will be described. FIG. 2 is a flowchart illustrating the method of manufacturing the optical fiber preform and the method of manufacturing the optical fiber according to some embodiments. In some embodiments, a porous body for forming the center core portion 11 and the depressed layer 12 is formed first (Step S101). Next, the porous body is subjected to heat treatment (hereinafter referred to as first heat treatment), and fluorine is added from the outer circumference (Step S102). Then, the heated porous body is subjected to heat treatment (hereinafter referred to as second heat treatment) at a higher temperature than that at Step S102 (Step S103). Thus, the porous body is vitrified to become a transparent glass body. Then, the cladding portion 13 is formed on the transparent glass body (Step S104). Thus, the desired optical fiber preform 10 is formed. Thereafter, the optical fiber preform 10 is drawn to manufacture an optical fiber (Step S105).

The method of manufacturing the optical fiber preform and the method of manufacturing the optical fiber according to some embodiments makes it possible, in two-step heat treatment, to appropriately add fluorine to the porous body as well as to dehydrate and sinter the porous body.

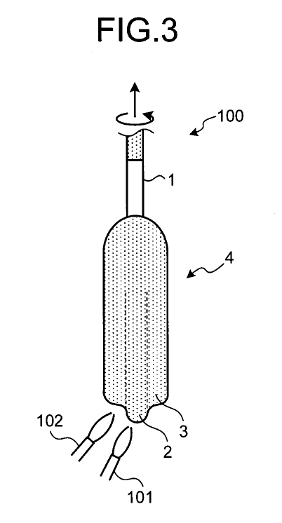

Next, each process will be described more specifically. FIG. 3 is a schematic diagram for explaining the porous body forming process at Step S101. A VAD device 100 illustrated in FIG. 3 supports a starting material 1, and includes a lifting mechanism (not illustrated) for lifting the starting material 1 while rotating the starting material 1, and concentric multiple pipe burners 101 and 102 for depositing quartz glass particles on the starting material 1.

In the porous body forming process, the starting material 1 made of quartz glass is set on the lifting mechanism, and is lifted while being rotated. At this time, the burner flame is applied to the lower part of the starting material 1 by the multiple pipe burners 101 and 102 while a given gas is supplied to the multiple pipe burners 101 and 102. Here, the multiple pipe burner 101 is supplied with silicon tetrachloride (SiCl₄) gas as a main source gas, germanium tetrachloride (GeCl₄) gas as a doping gas, hydrogen (H₂) gas as a combustible gas, oxygen (O₂) gas as a combustion enhancing gas, and an inert gas as a buffer gas. By hydrolysis reaction of such gases in the flame, synthetic quartz glass particles to which germanium is added are sprayed and deposited onto the starting material 1 to form a first region 2. Similarly, the multiple pipe burner 102 is supplied with SiCl₄ gas, H₂ gas, O₂ gas, and an inert gas to form a second region 3 made of synthetic quartz glass particles on an outer circumference of the first region 2. In this manner, a porous body 4 having the first region 2 and the second region 3 is formed.

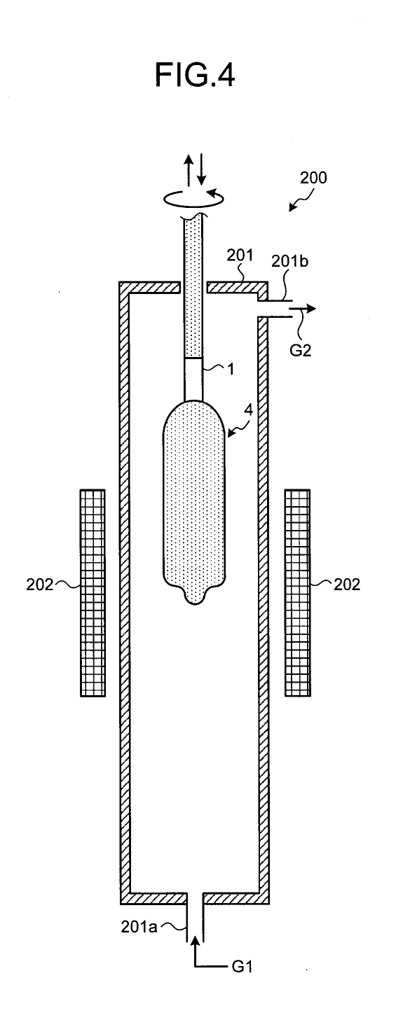

Next, the first heat treatment at Step S102 will be described. FIG. 4 is a schematic diagram for explaining the first heat treatment. A zone heating device 200 illustrated in FIG. 4 includes an elevating mechanism (not illustrated) for lifting and lowering the porous body 4 while rotating the porous body 4, a furnace core tube 201 made of quartz glass, and an annular heater 202 arranged to surround the circumference of the furnace core tube 201 at one part of a longitudinal direction of the furnace core tube 201. The furnace core tube 201 includes a gas introduction port 201a and a gas discharge port 201b.

In the first heat treatment, the starting material 1 attached on the porous body 4 is set on the elevating mechanism. Then, the porous body 4 is heated to a given temperature by the heater 202 while the porous body 4 is rotated and lowered. The porous body 4 is subjected to zone heating by the heater 202 and is dehydrated as the porous body 4 is lowered. In the heating, a gas G1 is supplied into the furnace core tube 201 through the gas introduction port 201a, and a gas G2 is discharged through the gas discharge port 201b.

In some embodiments, as the gas G1, a helium (He) gas that is gas used in a known dehydration process, a chlorine (Cl₂) gas having a dehydration function, and O₂ gas are supplied in addition to a fluorine (F) gas, and thus the porous body 4 is put under an atmosphere containing the fluorine gas. In this way, moisture and OH groups contained in the porous body 4 are removed, and fluorine is added to the second region 3.

Next, the second heat treatment at Step S103 can be performed using the zone heating device 200 in the same manner as in the first heat treatment except that the gas G1 to be supplied is an He gas and a Cl₂ gas and a temperature for heating the porous body 4 by the heater 202 is higher than that in the first heat treatment. Note that Cl₂ gas is not necessarily supplied. In this way, the porous body 4 is sintered and vitrified to become a transparent glass body. As a result, the center core portion 11 is formed from the first region 2, and the depressed layer 12 is formed from the second region 3.

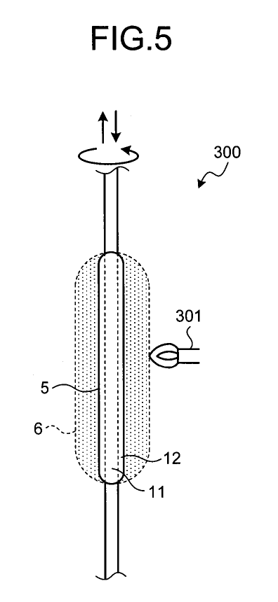

Next, the cladding portion forming process at Step S104 will be described. FIG. 5 is a schematic diagram for explaining the cladding portion forming process. An OVD device 300 illustrated in FIG. 5 includes an elevating mechanism (not illustrated) for lifting and lowering a drawn transparent glass body 5 while rotating the transparent glass body 5, and a multiple pipe burner 301 for depositing quartz glass particles on the transparent glass body 5 including the center core portion 11 and the depressed layer 12.

In the cladding portion forming process, the burner flame is applied to the drawn transparent glass body 5 by the multiple pipe burner 301 to which the same gases used for the multiple pipe burner 102 is supplied while the transparent glass body 5 is rotated, lifted and lowered by the elevating mechanism. In this way, the multiple pipe burner 301 causes the quartz glass particles to be deposited on the surface of the transparent glass body 5 while reciprocating relatively along a longitudinal direction of the transparent glass body 5. As a result, a third region 6 made of synthetic quartz glass particles is formed on the outer circumference of the transparent glass body 5. Next, the transparent glass body 5 having the third region 6 is heated using the zone heating device 200 illustrated in FIG. 4, whereby the third region 6 is vitrified to become the cladding portion 13. In this way, the optical fiber preform 10 is manufactured.

Thereafter, the optical fiber preform 10 is drawn by a known method at Step S105 to manufacture an optical fiber having substantially the same refractive index profile as that of the optical fiber preform 10.

As described above, the method of manufacturing the optical fiber preform and the method of manufacturing the optical fiber according to some embodiments enables two-step heat treatment for vitrification by adding fluorine in the first heat treatment. Thus, it is possible to manufacture an optical fiber preform more easily in a short time, and manufacture an optical fiber using the optical fiber preform.

Next, desirable structures of an optical fiber preform and desirable conditions for manufacturing the optical fiber preform will be described.

With respect to a bulk density of the porous body which is formed in the porous body forming process, a bulk density of the second region of the porous body is preferably 0.1 g/cm³ to 0.4 g/cm³. The bulk density equal to or more than 0.1 g/cm³ prevents the porous body from deforming under the porous body's own weight, which is preferable to maintain the entire shape, while the bulk density equal to or less than 0.4 g/cm³ is preferable for adding fluorine from the surface of the porous body easily and sufficiently. A bulk density of the first region may be, but is not limited to, 0.1 g/cm³ to 0.4 g/cm³ similarly to the second region, for example.

A ratio of the diameter of the first region to the outer diameter of the second region is preferably 1:1.5 to 1:6.5. If the ratio is equal to or more than 1:1.5, a bending loss is reduced due to the effect of the depressed layer in the manufactured optical fiber, which also results in the reduction in transmission loss. If the ratio is equal to or less than 1:6.5, fluorine can be added sufficiently to the second region, thus preventing the formation of a region to which fluorine is not added at a boundary between the first region and the second region. This makes it possible to reliably obtain a refractive index profile with a desired shape and to obtain an effect of reducing the bending loss more certainly. The ratio equal to or less than 1:6 is more preferable because the manufacturing becomes easier.

A partial pressure of the fluorine gas in the atmosphere of the first heat treatment is preferably 0.02% to 0.2%. The partial pressure is a pressure of the fluorine gas when the entire pressure in the zone heating furnace is 100%. If the partial pressure is equal to or more than 0.02%, fluorine can be sufficiently added to the second region, thus preventing the formation of a region to which fluorine is not added at a boundary between the first region and the second region. This makes it possible to reliably obtain a refractive index profile with a desired shape and to obtain an effect of reducing the bending loss more certainly. If the partial pressure is equal to or less than 0.2%, fluorine is not added excessively, thus preventing a situation where the relative refractive-index difference Δ2 of the depressed layer becomes excessively larger than a design value, or a situation where fluorine reaches the first region and the relative refractive-index difference Δ1 of the center core portion becomes smaller. If fluorine is added to the center core portion, the center core portion contains both germanium and fluorine, and a Rayleigh scattering loss may be increased.

A temperature in the first heat treatment is preferably 800° C. to 1250° C. When the temperature is equal to or higher than 800° C., impurities in the porous body are sufficiently removed, and the dehydration does not require long time. When the temperature is equal to or lower than 1250° C., the contraction of the porous body is suppressed even when the bulk density is small, thus maintaining the bulk density such that fluorine can be added sufficiently.

A temperature in the second heat treatment is preferably 1300° C. to 1450° C. When the temperature is equal to or higher than 1300° C., heat is conducted into the porous body sufficiently, thus enabling sufficient vitrification. The temperature equal to or lower than 1450° C. prevents a situation where the porous body is melted and deformed or a situation where the surface of the porous body is vitrified first and air bubbles remain inside of the porous body. If the air bubbles remain inside of the optical fiber preform, non-defective parts that can be used for manufacturing the optical fiber may be decreased and the transmission loss of the optical fiber may be increased.

A descending velocity of the porous body (i.e., a relative moving velocity of the porous body to the heater) in the first heat treatment is preferably 100 mm/h to 400 mm/h. Adjusting the descending velocity to a desirable one prevents the formation of a region to which fluorine is not added at a boundary between the first region and the second region. This makes it possible to reliably obtain a refractive index profile with a desired shape and to obtain an effect of reducing the bending loss more certainly. Moreover, fluorine is not added excessively, thus preventing a situation where the relative refractive-index difference Δ2 of the depressed layer becomes larger than a design value, or a situation where fluorine reaches the first region and the relative refractive-index difference Δ1 of the center core portion becomes smaller. The length of the first heat treatment time becomes optimum without being too long, which increases manufacturability. A descending velocity of the porous body in the second heat treatment may be set to be same as that in the first heat treatment, for example. It is preferable to appropriately adjust the descending velocity depending on a partial pressure of the fluorine gas or heating temperatures in the first and second heat treatment.

A partial pressure of the chlorine gas in the atmosphere in the first heat treatment is preferably 0.5% to 2.5%. The partial pressure is a pressure of the chlorine gas when the entire pressure in the zone heating furnace is 100%. If the partial pressure is equal to or more than 0.5%, moisture and OH groups are removed sufficiently by the dehydration effect of the chlorine gas, thus suppressing optical absorption with a peak at a wavelength of about 1380 nm due to OH groups. As a result, the transmission loss is decreased also at a wavelength of 1550 nm. If the partial pressure is equal to or less than 2.5%, germanium added to the first region is not vaporized due to the chlorine gas, thus preventing a situation where the relative refractive-index difference Δ1 of the center core portion becomes smaller than a design value. A partial pressure of the chlorine gas in the second heat treatment is preferably 0.5% to 2.5%.

### Examples and Comparative Example

Next, examples of the above-described embodiments will be explained. In the following examples, optical fiber preforms and optical fibers are manufactured by the method of manufacturing the optical fiber preform and the method of manufacturing the optical fiber according to the above-described embodiments under various manufacturing conditions. As a comparative example, an optical fiber preform and an optical fiber are manufactured in the same manner as in the examples except that fluorine is not added in the first heat treatment. In the following examples, a relative refractive-index difference Δ1 of the center core portion of the optical fiber preform is designed to be 0.3%, and a relative refractive-index difference Δ2 of the depressed layer is designed to be −0.1%.

First, in Example 1-1, an optical fiber preform is manufactured under the condition that a bulk density of the second region of the porous body is 0.2 g/cm³, a ratio of the outer diameter of the second region to the diameter of the first region is 5, a partial pressure of the fluorine gas in the first heat treatment is 0.2%, and a descending velocity of the porous body in the first and second heat treatments is 250 mm/h. Thereafter, the manufactured optical fiber preform is drawn to manufacture an optical fiber. In the optical fiber preform manufacturing condition, the temperatures in the first and second heat treatments are set to be 1000° C. and 1320° C., respectively, and a partial pressure of the chlorine gas is set to be a value in the above-mentioned desirable range. In Example 1-2, an optical fiber preform is manufactured under the same condition as in Example 1-1 except that a bulk density of the second region of the porous body is set to be about 0.6 g/cm³.

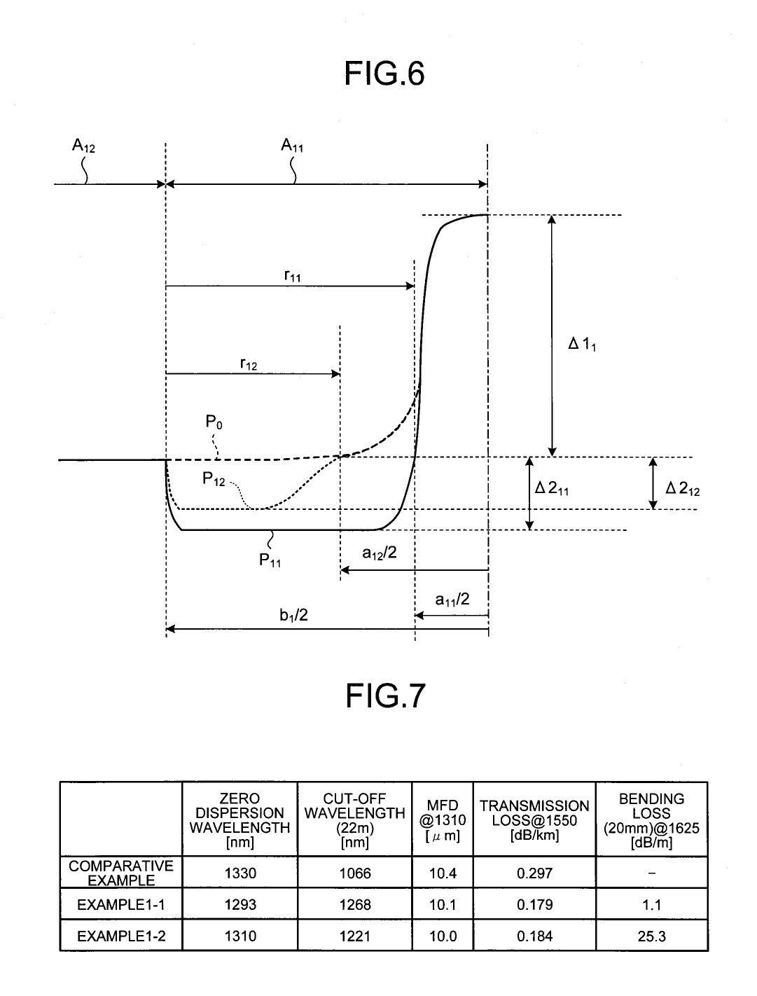

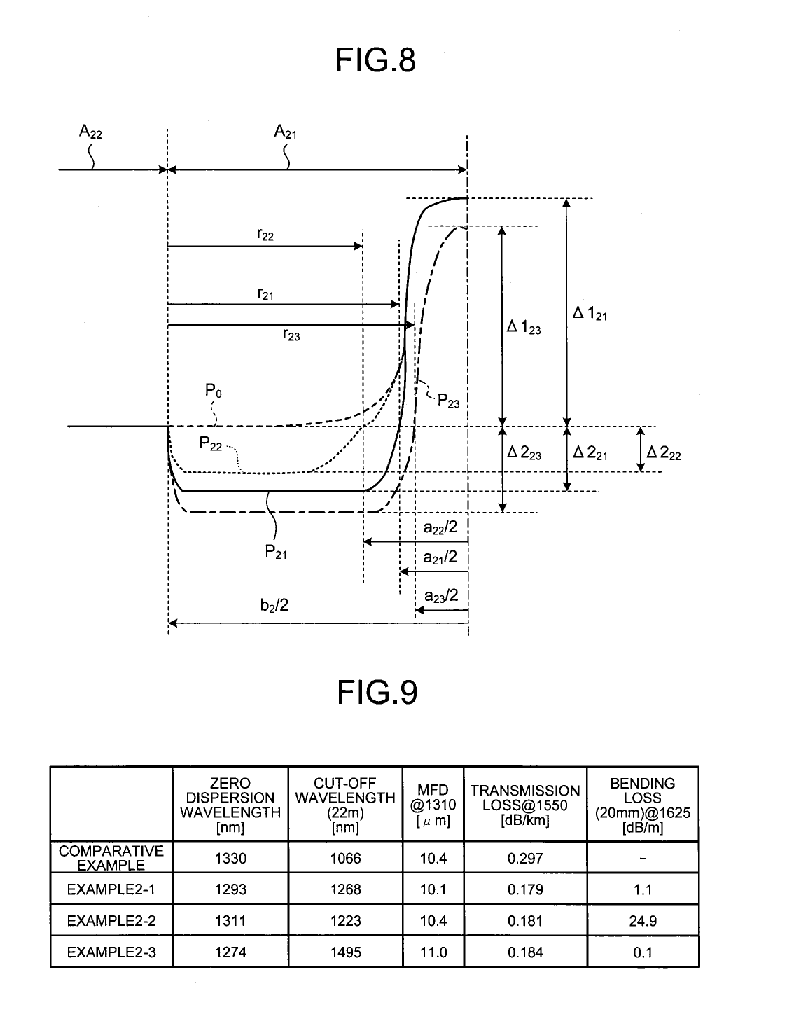

FIG. 6 is a schematic diagram illustrating refractive index profiles of optical fiber preforms of Comparative Example and Examples 1-1 and 1-2. FIG. 6, and FIGS. 8, 10, and 12 which will be described later, illustrate only a half of the refractive index profile with respect to a center axis of the center core portion.

In FIG. 6, a region A₁₁ represents a region formed altogether by the VAD method in the porous body forming process, and a region A₁₂ represents a region formed by the OVD method in the cladding portion forming process. Refractive index profiles P₁₁, P₁₂, and P₀ represent the refractive index profiles of the optical fiber preforms of Examples 1-1 and 1-2, and Comparative Example, respectively.

Moreover, Δ1₁ represents a relative refractive-index difference Δ1 of the refractive index profiles P₁₁, P₁₂, and P₀, Δ2₁₁ represents a relative refractive-index difference Δ2 of the refractive index profile P₁₁ in Example 1-1, and Δ2₁₂ represents a relative refractive-index difference Δ2 of the refractive index profile P₁₂ in Example 1-2. Furthermore, a₁₁ represents a core diameter in Example 1-1, and a₁₂ represents a core diameter in Example 1-2, while b₁ represents the outer diameter of the depressed layer in Examples 1-1 and 1-2, and Comparative Example.

In addition, r₁₁ and r₁₂ represent depths of penetration of the fluorine gas from the surface of the porous body in the first heat treatment in Examples 1-1 and 1-2, respectively. The depth of penetration is defined as {(outer diameter of depressed layer)−(core diameter)}/2.

As illustrated in FIG. 6, the relative refractive-index differences Δ1 of the respective refractive index profiles P₁₁, P₁₂, and P₀, which are denoted by Δ1₁, are nearly identical, and the value of Δ1₁ is about 0.3%. However, in Examples 1-1 and 1-2, Δ2₁₁ and Δ2₁₂ are −0.1% and −0.07%, respectively, and are increased as a bulk density is increased. With respect to the depths of penetration of the fluorine gas, r₁₁ is 0.7×b₁/2, and r₁₂ is 0.4×b₁/2 where b₁ represents a reference.

FIG. 7 is a table illustrating the characteristics of optical fibers manufactured using the optical fiber preforms of Comparative Example and Examples 1-1 and 1-2. The “MFD” in FIG. 7 represents a mode field diameter at a wavelength of 1310 nm. The transmission loss is of a value at a wavelength of 1550 nm. The bending loss is of a value at a wavelength of 1625 nm when the optical fiber is wound at a diameter of 20 mm.

In FIG. 7, a bending loss in Comparative Example is too large to measure. By contrast, the bending losses of the optical fibers in Examples 1-1 and 1-2 are low, and in particular, the bending loss in Example 1-1 is as small as 1.1 dB/m. The transmission losses in both Examples 1-1 and 1-2 are lower than 0.19 dB/km, which is a value of a typical transmission loss at a wavelength of 1550 nm of a single mode optical fiber compliant with ITU-T G.652. In particular, the transmission loss in Example 1-1 is 0.179 dB/km, which is a significantly small value less than 0.180 dB/km. In Example 1-2, a mode field diameter, a cut-off wavelength, and a zero-dispersion wavelength are compliant with the definitions of ITU-T G.652. The two-step heat treatment (i.e., the first heat treatment and the second heat treatment) is performed in both Examples 1-1 and 1-2, which enables easier manufacturing process with a reduced time as compared with conventional techniques.

The ITU-T G.652 defines, as characteristics of an optical fiber, a mode field diameter as 8.6 μm to 10.1 μm at a wavelength of 1310 nm, a cut-off wavelength as 1260 nm or less, and a zero-dispersion wavelength as 1300 nm to 1324 nm.

Next, in Example 2-1, an optical fiber preform is manufactured under the condition that a bulk density of the second region of the porous body is 0.2 g/cm³, a ratio of the outer diameter of the second region to the diameter of the first region is 5, a partial pressure of the fluorine gas in the first heat treatment is 0.2%, and a descending velocity of the porous body in the first and second heat treatments is 250 mm/h. Thereafter, the manufactured optical fiber preform is drawn to manufacture an optical fiber. In the optical fiber preform manufacturing conditions, the temperatures in the first and second heat treatments are set to be 1000° C. and 1320° C., respectively, and a partial pressure of the chlorine gas is set to be a value in the above-mentioned desirable range. In Examples 2-2 and 2-3, optical fiber preforms and optical fibers are manufactured under the same condition as in Example 2-1 except that partial pressures of the fluorine gas in the first heat treatment are set to be 0.02% and 0.5%, respectively.

FIG. 8 is a schematic diagram illustrating refractive index profiles of optical fiber preforms of Comparative Example and Examples 2-1 to 2-3. In FIG. 8, a region A₂₁ represents a region formed altogether by the VAD method in the porous body forming process, and a region A₂₂ represents a region formed by the OVD method in the cladding portion forming process. Refractive index profiles P₂₁, P₂₂, P₂₃, and P₀ represent the refractive index profiles of the optical fiber preforms of Examples 2-1, 2-2, and 2-3, and Comparative Example, respectively.

Moreover, Δ1₂₁ represents a relative refractive-index difference Δ1 of the refractive index profiles P₂₁, P₂₂, and P₀, Δ1₂₃ represents a relative refractive-index difference Δ1 of the refractive index profile P₂₃, and Δ2₂₁, Δ2₂₂, and Δ2₂₃ represent relative refractive-index differences Δ2 of the refractive index profiles P₂₁, P₂₂, and P₂₃, respectively. Furthermore, a₂₁, a₂₂, and a₂₃ represent the core diameters in Examples 2-1, 2-2, and 2-3, respectively, while b₂ represents the outer diameters of the depressed layers in Examples 2-1 to 2-3, and Comparative Example.

Moreover, r₂₁, r₂₂, and r₂₃ represent depths of penetration of the fluorine gas from the surface of the porous body in the first heat treatment in Examples 2-1, 2-2 and 2-3, respectively.

As illustrated in FIG. 8, the relative refractive-index differences Δ1 of the respective refractive index profiles P₁₁, P₁₂, and P₀, which are denoted by Δ1₂₁, are nearly identical, and the value of Δ1₂₁ is about 0.3%. However, a partial pressure of the fluorine gas is high in Example 2-3, and the relative refractive-index difference Δ1 of the refractive index profile P₂₃ in Example 2-3, which is denoted by Δ1₂₃, is smaller than Δ1₂₁, and the value of Δ1₂₃ is about 0.25%. Moreover, Δ2₂₁, Δ2₂₂, and Δ2₂₃ are −0.1%, −0.07%, and −0.14%, respectively, and are decreased as a partial pressure of the fluorine gas is increased. With respect to the depths of penetration of the fluorine gas, r₂₁ is 0.7×b₂/2, r₂₂ is 0.5×b₂/2, and r₂₃ is 0.75×b₂/2 where b₂ represents a reference.

FIG. 9 is a table illustrating the characteristics of optical fibers manufactured using the optical fiber preforms of Comparative Example and Examples 2-1 to 2-3. In FIG. 9, the bending losses of the optical fibers in Examples 2-1 to 2-3 are low, and in particular, the bending loss in Example 2-3 is as small as 0.1 dB/m. The transmission losses in all of Examples 2-1 to 2-3 are lower than 0.19 dB/km. The transmission loss is low when the partial pressure of the fluorine gas is 0.02% to 0.2%, as in Examples 2-1 and 2-2, which is more preferable. The two-step heat treatment (i.e., the first heat treatment and the second heat treatment) is performed in all of Examples 2-1 to 2-3, which enables easier manufacturing process with a reduced time as compared with conventional techniques.

Next, in Example 3-1-1, an optical fiber preform is manufactured under the condition that a bulk density of the second region of the porous body is 0.2 g/cm³, a ratio of the outer diameter of the second region to the diameter of the first region is 5, a partial pressure of the fluorine gas in the first heat treatment is 0.02%, and the descending velocities of the porous body in the first and second heat treatments are 150 mm/h and 250 mm/h, respectively. Thereafter, the manufactured optical fiber preform is drawn to manufacture an optical fiber. In the optical fiber preform manufacturing condition, the temperatures in the first and second heat treatments are set to be 1000° C. and 1320° C., respectively, and a partial pressure of the chlorine gas is set to be a value in the above-mentioned desirable range.

In Example 3-1-2, an optical fiber preform and an optical fiber are manufactured under the same condition as in Example 3-1-1 except that a descending velocity of the porous body in the first heat treatment is set to be 250 mm/h. In Example 3-2-1, an optical fiber preform and an optical fiber are manufactured under the same condition as in Example 3-1-1 except that a partial pressure of the fluorine gas in the first heat treatment is set to be 0.2%. In Example 3-2-2, an optical fiber preform and an optical fiber are manufactured under the same condition as in Example 3-2-1 except that a descending velocity of the porous body in the first heat treatment is set to be 300 mm/h. In Example 3-2-3, an optical fiber preform and an optical fiber are manufactured under the same condition as in Example 3-2-1 except that a temperature in the first heat treatment is set to be 800° C. In Example 3-2-4, an optical fiber preform and an optical fiber are manufactured under the same condition as in Example 3-2-1 except that a descending velocity of the porous body in the first heat treatment is set to be 250 mm/h and a temperature in the first heat treatment is set to be 1220° C. In Example 3-2-5, an optical fiber preform and an optical fiber are manufactured under the same condition as in Example 3-2-4 except that a temperature in the first heat treatment is set to be 1100° C.

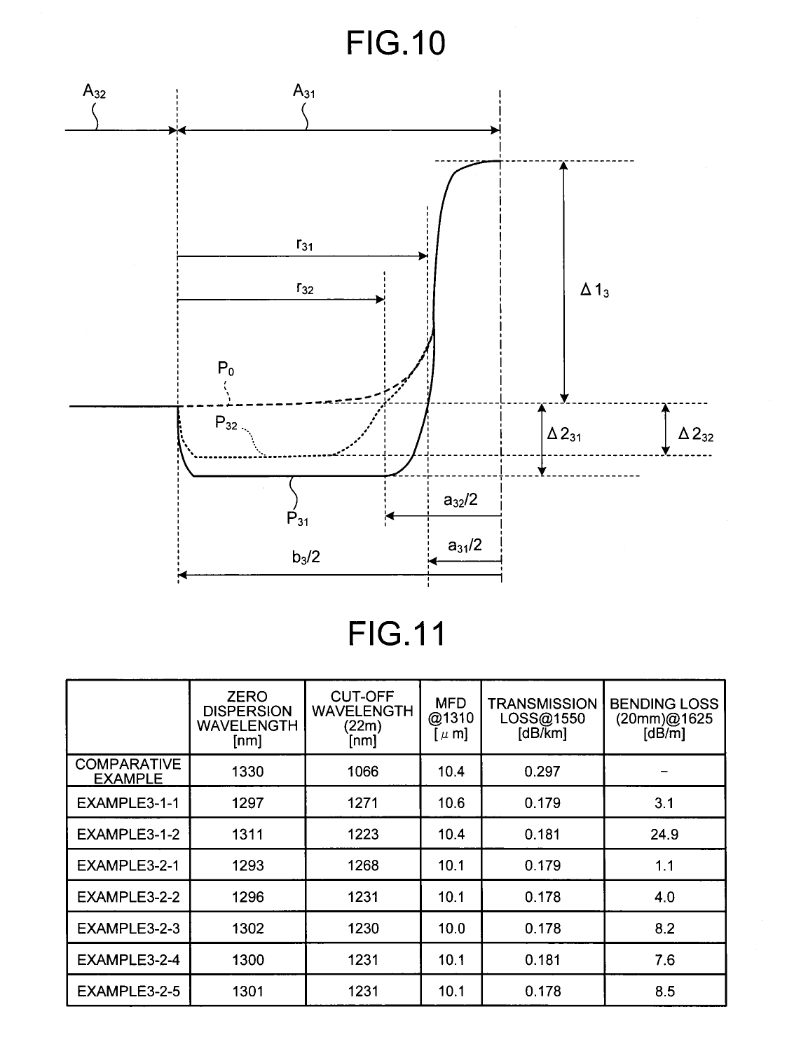

FIG. 10 is a schematic diagram illustrating refractive index profiles of optical fiber preforms of Comparative Example and Examples 3-1-1 and 3-1-2. In FIG. 10, a region A₃₁ represents a region formed altogether by the VAD method in the porous body forming process, and a region A₃₂ represents a region formed by the OVD method in the cladding portion forming process. Refractive index profiles P₃₁, P₃₂, and P₀ represent the refractive index profiles of optical fiber preforms of Examples 3-1-1 and 3-1-2, and Comparative Example, respectively.

Moreover, Δ1₃ represents a relative refractive-index difference Δ1 of the refractive index profiles P₃₁, P₃₂, and P₀, and Δ2₃₁ and Δ2₃₂ represent relative refractive-index differences Δ2 of the refractive index profiles P₃₁ and P₃₂, respectively. Furthermore, a₃₁ and a₃₂ represent the core diameters in Example 3-1-1 and 3-1-2, respectively, while b₃ represents the outer diameter of the depressed layer of Examples 3-1-1 and 3-1-2, and Comparative Example.

Moreover, r₃₁ and r₃₂ represent depths of penetration of the fluorine gas from the surface of the porous body in the first heat treatment in Examples 3-1-1 and 3-1-2, respectively.

As illustrated in FIG. 10, the relative refractive-index differences Δ1 of the respective refractive index profiles P₃₁, P₃₂, and P₀, which are denoted by Δ1₃, are nearly identical, and the value of Δ1₃ is about 0.3%. However, Δ2₃₁ and Δ2₃₂ are −0.1% and −0.07%, respectively, and are increased as a descending velocity is increased. With respect to the depths of penetration of the fluorine gas, r₃₁ is 0.7×b₃/2, and r₃₂ is 0.5×b₃/2 where b₃ represents a reference.

FIG. 11 is a table illustrating the characteristics of optical fibers manufactured using the optical fiber preforms of Comparative Example and Examples 3-1-1 to 3-2-5. In FIG. 11, the bending losses of the optical fibers in Examples 3-1-1 to 3-2-2 are low. The transmission losses in all of Examples 3-1-1 to 3-2-5 are lower than 0.19 dB/km. In particular, the transmission losses in Examples 3-1-1, 3-2-1, 3-2-2, 3-2-3, and 3-2-5 are lower than 0.18 dB/km. In Examples 3-2-3 to 3-2-5, a mode field diameter, a cut-off wavelength, and a zero-dispersion wavelength are compliant with the definitions of ITU-T G.652. The two-step heat treatment (i.e., the first heat treatment and the second heat treatment) is performed in all of Examples 3-1-1 to 3-2-5, which enables easier manufacturing process with a reduced time as compared with conventional techniques. In Example 3-2-2, a partial pressure of the fluorine gas is set to be higher as compared with Example 3-1-1, whereby a low transmission loss can be achieved although the descending velocity is set to be relatively high.

Next, in Example 4-1, an optical fiber preform is manufactured under the condition that a bulk density of the second region of the porous body is 0.2 g/cm³, a ratio of the outer diameter of the second region to the diameter of the first region is 5, a partial pressure of the fluorine gas in the first heat treatment is 0.2%, and a descending velocity of the porous body in the first and second heat treatments is 250 mm/h. Thereafter, the manufactured optical fiber preform is drawn to manufacture an optical fiber. In the optical fiber preform manufacturing condition, the temperatures in the first and second heat treatments are set to be 1000° C. and 1320° C., respectively, and a partial pressure of the chlorine gas is set to be a value in the above-mentioned desirable range. In Example 4-2, an optical fiber preform and an optical fiber are manufactured under the same condition as in Example 4-1 except that a ratio of the outer diameter of the second region to the diameter of the first region is set to be 6.

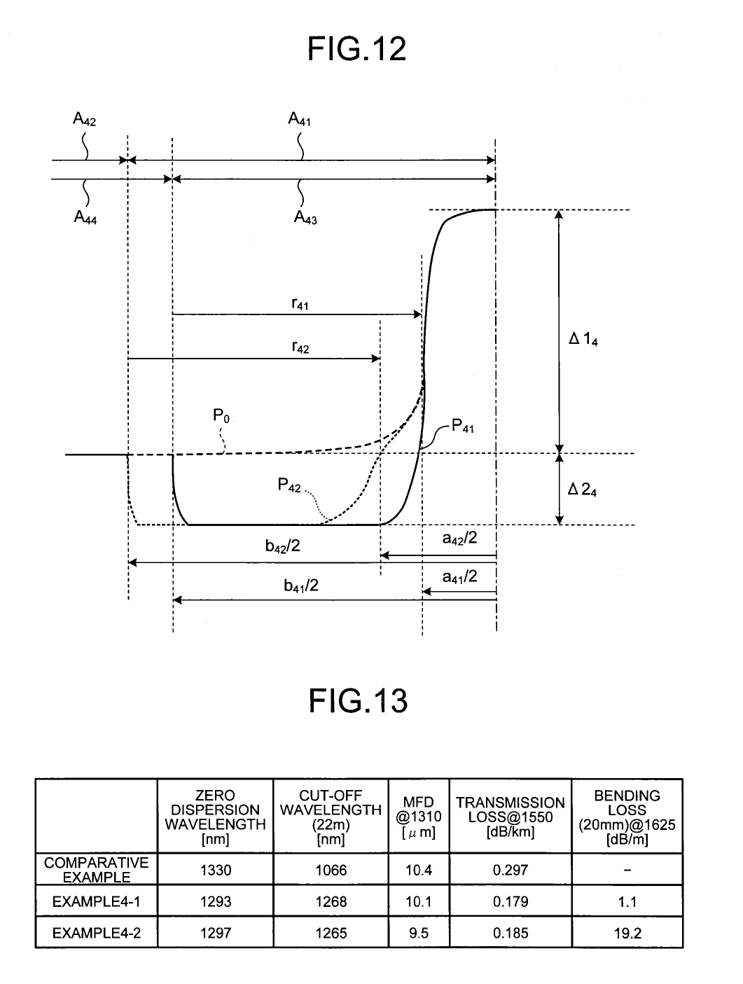

FIG. 12 is a schematic diagram illustrating refractive index profiles of optical fiber preforms of Comparative Example and Examples 4-1 and 4-2. In FIG. 12, regions A₄₁ and A₄₃ represent regions formed altogether by the VAD method in the porous body forming process in Examples 4-1 and 4-2, respectively, and regions A₄₂ and A₄₄ represent regions formed by the OVD method in the cladding portion forming process in Examples 4-1 and 4-2, respectively. Refractive index profiles P₄₁, P₄₂, and P₀ represent the refractive index profiles of optical fiber preforms of Examples 4-1 and 4-2, and Comparative Example, respectively.

Moreover, Δ1₄ represents a relative refractive-index difference Δ1 of the refractive index profiles P₄₁, P₄₂, and P₀, and Δ2₄ represents a relative refractive-index difference Δ2 of the refractive index profiles P₄₁ and P₄₂. Furthermore, a₄₁ and a₄₂ represent the core diameters in Examples 4-1 and 4-2, respectively, while b₄₁ and b₄₂ represent the outer diameters of the depressed layers in Examples 4-1 and 4-2, respectively.

Moreover, r₄₁ and r₄₂ represent depths of penetration of the fluorine gas from the surface of the porous body in the first heat treatment in Examples 4-1 and 4-2, respectively.

As illustrated in FIG. 12, the relative refractive-index differences Δ1 and Δ2 of the refractive index profiles P₄₁, P₄₂, and P₀, which are denoted by Δ1₄ and Δ2₄, respectively, are nearly identical, and the values of Δ1₄ and Δ2₄ are about 0.3% and about −0.1%, respectively. With respect to the depths of penetration of the fluorine gas, r₄₁ and r₄₂ are equal. However, the outer diameter of the second region of the porous body is larger in Example 4-2, and thus the fluorine gas is not penetrated into the entirety of the second region. As a result, the core diameter a₄₂ in Example 4-2 is 1.6 times as large as the core diameter a₄₁ in Example 4-1.

Next, FIG. 13 is a table illustrating the characteristics of optical fibers manufactured using the optical fiber preforms of Comparative Example, and Examples 4-1 and 4-2. In FIG. 13, the bending losses of the optical fibers in Examples 4-1 and 4-2 are low. The transmission losses in both Examples 4-1 and 4-2 are lower than 0.19 dB/km. The two-step heat treatment (i.e., the first heat treatment and the second heat treatment) is performed in both Examples 4-1 and 4-2, which enables easier manufacturing process with a reduced time as compared with conventional techniques.

In the examples described above, the relative refractive-index difference Δ1 of the center core portion is set to be 0.3%, which is smaller than a relative refractive-index difference Δ1 of a single mode optical fiber having a step index refractive index profile compliant with ITU-T G.652. Thus, quantity of germanium contained in the center core portion is reduced to suppress an optical loss due to Rayleigh scattering, and a transmission loss at a wavelength of 1550 nm is reduced to be equal to or less than 0.185 dB/km, or more preferably, to be equal to or less than 0.18 dB/km, for example. In this manner, the Δ1 is set to be small in the optical fiber preforms and the optical fibers of the examples. However, the increase of a bending loss is suppressed by forming a depressed layer to obtain a W-shaped refractive index profile. The relation between Δ1 and Δ2 is preferably |Δ1|:|Δ2|=3:1 as a ratio of absolute values, under conditions of viscosity match of glass materials at a boundary between the center core portion and the depressed layer. Thus, it is preferable that Δ1=0.3%, and Δ2=−0.1%, as in the examples described above. It is noted that Δ2 may be −0.05%. The core diameter of the center core portion may be 10 μm. The ratio of the diameter of the center core portion to the outer diameter of the depressed layer is preferably 1:4 to 1:5. The W-shaped refractive index profile increases a mode field diameter, which reduces a fusion splicing loss and optical nonlinearity of an optical fiber. Moreover, the cut-off wavelength can be a value compliant with ITU-T G.652 by adjusting the relative refractive-index difference and the outer diameter of the depressed layer.

As design parameters, relative refractive-index differences Δ1 and Δ2, a core diameter, and the outer diameter of the depressed layer are not limited to the values in the examples described above, and can be appropriately set to achieve desired optical characteristics.

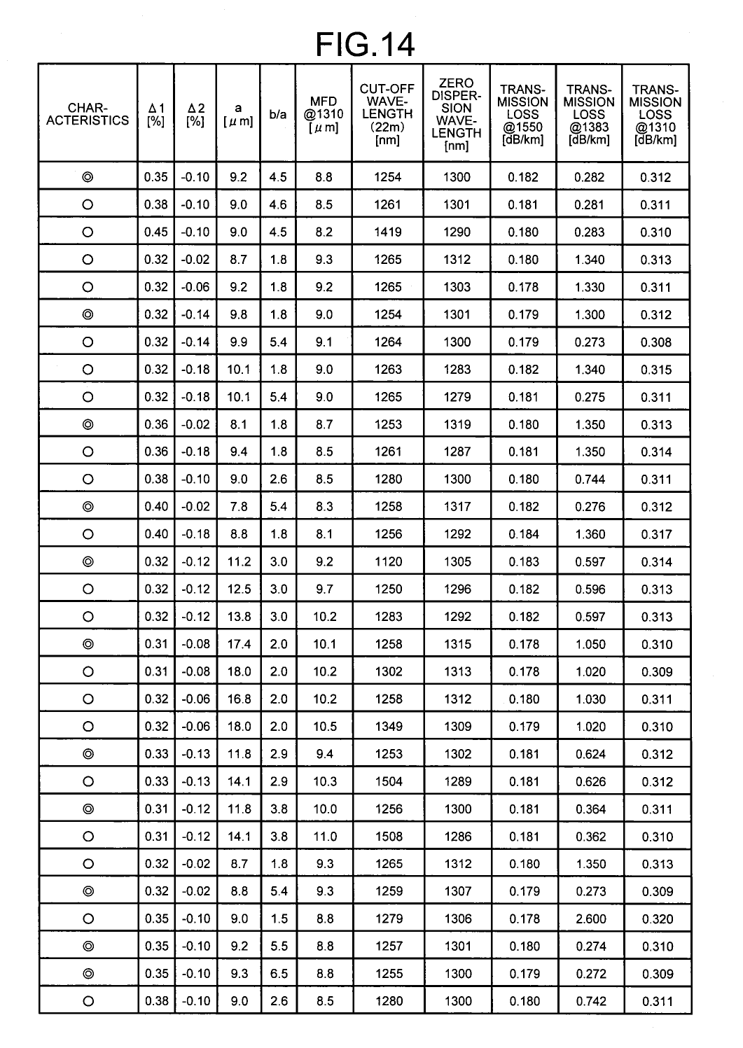

FIG. 14 is a table illustrating examples of preferable design parameters of optical fibers manufactured by the manufacturing method according to some embodiments, and the characteristics of the optical fibers achieved by the design parameters. Here, “b/a” indicates (outer diameter of depressed layer)/(core diameter). A circle in the item “characteristics” indicates that the transmission loss at a wavelength of 1550 nm is equal to or less than 0.185 dB/km. A double circle in the item “characteristics” indicates that the mode field diameter is 8.6 μm to 10.1 μm, the cut-off wavelength is equal to or smaller than 1260 nm, and the zero-dispersion wavelength is 1300 nm to 1324 nm.

As illustrated in FIG. 14, the optical fiber manufactured by the manufacturing method according to some embodiments allows a transmission loss at a wavelength of 1550 nm to be equal to or less than 0.185 dB/km. Moreover, when Δ1 is 0.3% to 0.45%, Δ2 is −0.2% to −0.02%, a core diameter is 7.8 μm to 18.0 μm, and a ratio of the core diameter to the outer diameter of the depressed layer is 1:1.5 to 1:6.5, it is possible to achieve an optical fiber having a mode field diameter of 8.6 μm to 11.0 μm, a cut-off wavelength equal to or less than 1550 nm, and a zero-dispersion wavelength of 1280 nm to 1340 nm, thus enabling nearly the same use as a single mode optical fiber (SMF) compliant with ITU-T G.652. When Δ1 is equal to or less than 0.4% and Δ2 is equal to or more than −0.15% in the setting of the above-mentioned design parameters, it is possible to achieve an optical fiber having a mode field diameter of 8.6 μm to 10.1 μm, a cut-off wavelength equal to or less than 1260 nm, and a zero-dispersion wavelength of 1300 nm to 1324 nm, which can be compliant with ITU-T G.652. With respect to all design parameters illustrated in FIG. 14, the bending loss is equal to or less than 30 dB/m at a wavelength of 1625 nm when the optical fiber is wound at a diameter of 20 mm.

In the above-described embodiments, the OVD method is employed to form a cladding portion. Alternatively, a cladding portion may be formed by inserting a transparent glass body into a quartz glass tube to be integrated with each other. Moreover, the method of forming a porous body is not limited to the VAD method, and other known method such as the modified chemical vapor deposition (MCVD) method may be used. Furthermore, other dopant for adjusting a refractive index such as phosphorus (P), in addition to germanium or instead of germanium, may be added to the first region of the porous body. Alternatively, dopant for adjusting a refractive index may not be added.

The present invention includes a reasonable combination of the above-described configurations. The present invention includes any other embodiments, examples, and operation techniques, etc. that are made based on the embodiments described above by a parson skilled in the art, etc.

According to the above-mentioned embodiments, two-step heat treatment for vitrifying a porous body makes it possible to manufacture an optical fiber preform and an optical fiber using the optical fiber preform more easily in a short time.

As describe above, a method of manufacturing an optical fiber preform and a method of manufacturing an optical fiber according to some embodiments are suitable for use in optical fibers mainly for optical communications.

According to the optical fiber of some embodiments, fluorine is not added to the center core portion 11, and therefore a minimum amount of germanium required for a sufficient refractive index is added to the center core portion 11. With this structure, an increase in a Rayleigh scattering loss can be suppressed.

In addition, because a manufacturing boundary is not generated between the center core portion 11 and the depressed layer 12, structural unconformity of glass is not likely to occur between the center core portion 11 and the depressed layer 12, and thus low-loss optical fiber can be obtained at a wavelength of 1550 nm. The “manufacturing boundary” is a boundary generated between neighboring cycles in a manufacturing process. Here, one cycle is defined as a cycle during which a porous body made of glass particles is formed and then heat treatment is performed on the porous body to form a transparent glass body. That is, the manufacturing boundary is a deposition surface where a porous body is deposited on the already-formed transparent glass body.

Further, mixing of OH groups can be suppressed, and thus the transmission loss at a wavelength of 1380 nm can also be reduced using a simple manufacturing method.

If a center core portion and a depressed layer are manufactured in a single step and fluorine is added to all regions of the center core portion and the depressed layer, the fluorine is added to a central portion of an optical fiber. Therefore, both fluorine and germanium are added to the center core portion, thus Rayleigh scattering loss may be increased.

In contrast, if a center core portion and a depressed layer are manufactured in different steps, the manufacturing boundary is generated between the center core portion and the depressed layer, and therefore the structural unconformity of glass is likely to occur. Since the boundary between the center core portion and the depressed layer is positioned within mode field or in the vicinity of the mode field, the structural unconformity of glass has a negative impact on the transmission loss.

In addition, OH groups are likely to be mixed into the manufacturing boundary. Therefore, it is necessary to devise a manufacturing method by, for example, providing a step of removing OH groups in order to reduce the transmission loss at a wavelength of 1380 nm.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of manufacturing an optical fiber preform, comprising:
forming a porous body that is made of glass particles and includes a first region and a second region formed on an outer circumference of the first region;
performing a first heat treatment on the porous body under an atmosphere containing a fluorine gas;
performing a second heat treatment on the porous body after the first heat treatment at a higher temperature than that of the first heat treatment to form a transparent glass body; and
forming a cladding portion on an outer circumference of the transparent glass body.

2. The method of manufacturing the optical fiber preform according to claim 1, wherein a bulk density of the second region of the porous body is 0.1 g/cm³ to 0.4 g/cm³.

3. The method of manufacturing the optical fiber preform according to claim 1, wherein a ratio of a diameter of the first region to an outer diameter of the second region is 1:1.5 to 1:6.5.

4. The method of manufacturing the optical fiber preform according to claim 1, wherein a partial pressure of the fluorine gas in the atmosphere of the first heat treatment is 0.02% to 0.2%.

5. The method of manufacturing the optical fiber preform according to claim 1, wherein a temperature in the first heat treatment is 800° C. to 1250° C.

6. The method of manufacturing the optical fiber preform according to claim 1, wherein a temperature in the second heat treatment is 1300° C. to 1450° C.

7. The method of manufacturing the optical fiber preform according to claim 1, wherein
the first heat treatment is performed by moving the porous body relative to a heating region, and
a relative moving velocity of the porous body to the heating region is 100 mm/h to 400 mm/h.

8. The method of manufacturing the optical fiber preform according to claim 1, wherein
the atmosphere in the first heat treatment contains a chlorine gas, and
a partial pressure of the chlorine gas in the atmosphere is 0.5% to 2.5%.

9. An optical fiber comprising:
a center core portion located at a center of the optical fiber;
a depressed layer that surrounds the center core portion and has a refractive index lower than that of the center core portion; and
a cladding portion that surrounds the depressed layer and has a refractive index lower than that of the center core portion and higher than that of the depressed layer,
wherein a manufacturing boundary is not generated between the center core portion and the depressed layer, and
fluorine is added to the depressed layer, and fluorine is not added to the center core portion.

10. The optical fiber according to claim 9, wherein a transmission loss at a wavelength of 1550 nm is equal to or less than 0.185 dB/km.

11. The optical fiber according to claim 9, wherein a transmission loss at a wavelength of 1310 nm is equal to or less than 0.40 dB/km.

12. The optical fiber according to claim 9, wherein
a relative refractive-index difference of the center core portion to the cladding portion is 0.3% to 0.45%,
a relative refractive-index difference of the depressed layer to the cladding portion is −0.2% to −0.02%,
a diameter of the center core portion is 7.8 μm to 18.0 μm,
a ratio of the diameter of the center core portion to an outer diameter of the depressed layer is 1:1.5 to 1:6.5,
a mode field diameter at a wavelength of 1310 nm is 8.6 μm to 11.0 μm,
a cut-off wavelength is equal to or less than 1550 nm, and
a zero-dispersion wavelength is 1280 nm to 1340 nm.

13. The optical fiber according to claim 11, wherein
a relative refractive-index difference of a center core portion formed of the first region to the cladding portion is equal to or less than 0.4%,
a relative refractive-index difference of a depressed layer formed of the second region to the cladding portion is equal to or more than −0.15%,
a mode field diameter at a wavelength of 1310 nm is 8.6 μm to 10.1 μm,
a cut-off wavelength is equal to or less than 1260 nm, and
a zero-dispersion wavelength is 1300 nm to 1324 nm.

14. The optical fiber according to claim 9, wherein
a ratio of a diameter of the center core portion to an outer diameter of the depressed layer is 1:3.8 to 1:6.5, and
a transmission loss at a wavelength of 1383 nm is equal to or less than 0.40 dB/km.
